(19) United States
(12) Patent Application Publication
(10) Pub. No.: US 2020/0172402 A1
(43) Pub. Date: Jun. 4, 2020

(54) COMPOSITE CARBON-CARBON PARTICLES

(71) Applicant: PHILLIPS 66 COMPANY, HOUSTON, TX (US)

(72) Inventor: Zhenhua Mao, Bartlesville, OK (US)

(73) Assignee: PHILLIPS 66 COMPANY, HOUSTON, TX (US)

(21) Appl. No.: 16/209,609

(22) Filed: Dec. 4, 2018

(51) Int. Cl. C01B 32/205; C01B 32/215; C01B 32/23; H01M 4/1393

(52) U.S. Cl. CPC C01B 32/205; C01B 32/215; H01M 2004/027; H01M 4/1393; C01P 2004/80; C01B 32/23

(57) ABSTRACT

Carbon particles are coated with a water-soluble carbon residue material by oxidizing the carbon residue in water and forming a solid coating on the particles. The coated particles may be heated to graphite forming temperatures to prepare the coated particles for use an anode powder for a battery.

### CROSS-REFERENCE TO RELATED APPLICATIONS

None.

### STATEMENT REGARDING FEDERALLY SPONSORED RESEARCH OR DEVELOPMENT

None.

### FIELD OF THE INVENTION

This invention relates to carbon particles having a carbon coating that are used as anode material in electric energy storage devices and especially in batteries.

### BACKGROUND OF THE INVENTION

Graphitized coated carbon particles have been in use as anode materials in batteries for a number of years. The advantage of graphitized coated carbon materials is that the smooth outer coating protects the otherwise rough surfaces and edges of the graphite sheets within the underlying particles. Although the coating is also graphitic, the coating, when properly formed, is chemically bonded smooth and bonded thin with a graphite structure that allows lithium ions to pass through the coating while keeping the electrolyte away from the broader graphite sheets in the underlying particles. Without such protection by the carbon coating, the graphite sheets are fragile and vulnerable to the chemical or electrochemical degradation caused by the decomposition of electrolyte and the insertion of solvents during charge and discharge cycles. This is a significant cause for shortened battery life and for battery failures. The carbon coating is much more resistant to any electrochemical flexing, fracturing and loss of storage capacity in the graphite sheets. And, as the graphite in the coating are thin and small and aligned with the graphite sheets of the substrate particles, it is more tolerant of the small amount of flexing that the electrolyte can impose.

With the recognized advantage of lithium ion batteries being made with graphitized coated carbon particles, the processes for coating the graphite precursor carbon materials continues to be a challenge. Petroleum coke tends to be an attractive substrate, but there are two most preferred techniques for coating the coke particles that each have limitations and challenges.

Coating coke with coal tar pitch has been found to be relatively easy and simple to accomplish. The pitch is added to the fine coke powder in a mixing and granulating step that forces the two together creating compound pellets of coke and pitch. The compound pellets are calcined for converting the pitch to carbon. The carbonized pitch and coke compound pellets are then milled and classified to obtain powder size materials (˜15-25 μm) that comprise carbon-composite particles. During the first and second milling and classifying steps, ultra-fine portions of the materials are eliminated from the process greatly reducing the yield of anode battery powder material from the raw materials. About 40% and sometimes more of the product is unfit for use in a battery. In addition, such carbon composite particles are not perfect in carbon coating because some external surface areas of the coke particles end up uncovered and exposed.

Coating coke particles using a selective solvent deposition method provides more robust particles but the process of applying the coating has been a challenge. First, the process requires relatively precise adherence to complicated operational controls for coating carbon precursor on coke particles and stabilizing the coated particles without agglomerating. In addition, the solvents used are expensive and must be recovered and recycled and handled in strict compliance with environmental regulations.

What is desired is a simpler and more economic process for applying a smooth and adhesive coating on to carbon particles for eventual graphitization and for use as an anode in lithium ion batteries. With the production of battery powered vehicles rapidly increasing along with the expanding use of portable electronic devices, demand for reliable and long life electric power storage is clearly going to increase at a substantial rate.

### BRIEF SUMMARY OF THE DISCLOSURE

The invention more particularly includes a process for producing core and shell particles where both the core and the shell are carbon-based materials that are precursors for graphitic battery anode powder. The process is accomplished by dissolving a water-soluble carbon precursor in water to form a liquid coating solution. Calcined petroleum coke is added to water to form a dispersion. The water-soluble carbon precursor is deposited onto the calcined petroleum coke as a coating by oxidizing the water-soluble carbon precursor to form a solidified coating. The coated particles are then separated from the dispersion.

The invention may also be described as a process for producing graphitic anode powder comprising core and shell particles where both the core and the shell are carbon-based materials where the anode powder is suitable for use in the anode of a battery. The process is accomplished by dissolving a water-soluble carbon precursor in water to form a liquid coating solution while also dispersing calcined petroleum coke in water to form a dispersion. The water-soluble carbon precursor is deposited as a coating on the calcined petroleum coke by oxidizing the water-soluble carbon precursor to form a solidified coating. The coated particles are then separated from the dispersion, washed and heated in an oxygen free environment to convert the carbon precursor materials in the core and shell to graphite structures.

### BRIEF DESCRIPTION OF THE DRAWINGS

A more complete understanding of the present invention and benefits thereof may be acquired by referring to the follow description taken in conjunction with the accompanying drawings in which:

FIG. 1 is a photograph of a poorly coated carbon particle where the underlying graphite structure is readily visible; and

FIG. 2 is a photograph of a well-coated particle suitable for use as anode in a lithium ion battery where the coating is smooth and continuous to protect the underlying graphite structure from the electrolyte while permit ions to pass through in and out of the graphite storage inside the particle.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

The desire for attractive anode powder is micron sized particles comprising a graphite core with an unaligned smooth and continuous graphite coating. The formation of such particles does not have to start with naturally occurring graphite or synthetic graphite that is to be coated, but rather a carbon precursor core with a carbon precursor coating. The precursors should be sufficiently different that when they are subject to graphite conditions (very high temperatures) the formation of the graphite crystals occurs distinct in one another although they are contiguous.

Premium petroleum coke is excellent precursor material in that it has really high carbon content and excludes contaminants that evolve in the graphitization process that disrupt the formation of extensive graphite sheets in the core portion of the coated particles.

For the coating, there are many choices, but the process of coating is not so easy. However, one class of carbon precursor material has been studied. Lignin is term describing complex organic polymers that are found in the cell walls of many plants, making them rigid and woody. Chemically, they are described as cross-linked phenolic polymers. Most lignins are generally insoluble in water, but alkali lignin is known to be water-soluble. Being an organic material, it comprises a significant proportion of carbon although it includes oxygen, hydrogen and other heteroatoms. Being water-soluble, alkali lignin is amenable to being applied as a coating on solid particles via a precipitation process.

Since many pitches that are candidate coating materials are known to melt and foam easily when heated, the processes must be carefully and precisely designed and controlled. Foaming of the coating renders it unsuitable for battery powder.

The process for coating carbon precursor material in an aqueous process includes dissolving the coating material in water and getting the premium petroleum coke material to form a dispersion in the water. It is preferred to stir the coke into water although sometimes the coke is resistant to wetting, some wetting-aiding agents may be used. Typical wetting agent are organic compounds that are soluble in both aqueous and non-aqueous liquids such as any detergents, surfactants, solvent acetone or NMP (N-methyl-2-pyrrolidone), etc. The alkali lignin may be dissolved into this dispersion but is preferably dissolved in water first before being combined with the coke whether by stirring the coke into the dissolved lignin or the dissolved lignin combined with the dispersion of coke in water.

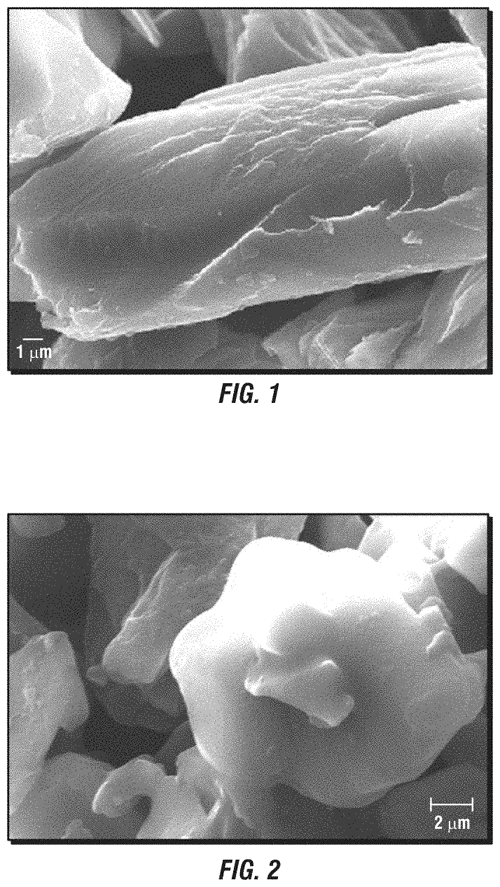

The alkali lignin is precipitated on to the coke particles by oxidation by the addition of a liquid oxidant. The preferred oxidant is nitric acid, HNO₃, but other oxidant liquids may also suffice. It is important to get a good coating on to the surface of the core coke particle as much of the coating will be lost in the graphitization process as the heteroatoms will be driven off to leave only carbon that forms the graphite crystals. Referring to FIG. 1, the coating on the core particle is thin and insufficient to protect the graphite in the core particle. The alkali lignin oxidized on the particle using nitric acid provides a nice continuous coating as shown in FIG. 2 which is smooth and complete.

What is really attractive is the oxidation process is not simply a cross linking process but provides stable coating that is not amenable to agglomeration. Agglomeration is a real problem when it occurs as it will eventually be broken and leave ragged edges that themselves become vulnerable to the degradation process that the coating is intended to protect the underlying graphite from.

One aspect of the invention that seems to make the process more robust is to pre-calcine the coke particle to a fairly high temperature prior to coating. Coke particles that were pre-calcined to 950° C. were not as satisfactory as those calcined to 1350° C. It is supposed that coke that is pre-calcined to a temperature between 950° C. and 2000° C. will be fully satisfactory such as above 1000° C. or above 1200° C. or more preferably 1400° C. The coating bonds better to the pre-calcined coke and shrinks with the underlying coke particle while enduring subsequent heat treatments.

It is very attractive that this is an aqueous process in that although not all of the alkali lignin precipitates out of the water solution, the solution may be re-used with added lignin to be deposited in a subsequent step of adding the liquid oxidant without concern for recovering or disposing of the water like one would have with a solvent deposition process.

The now coated particle may be washed and dried and then heated in an oxygen free or inert environment up to graphitic temperatures such as above 2900° C. Along the way to such high temperatures, which may be administered at relatively rapid progression without worry about melting the carbon precursor as would normally be a concern with thermoplastic coatings.

The heating process may be accomplished in a two-step process where the heteroatoms are driven off in a process described as carbonization. The carbon precursors are thereby rendered to carbon. This is done experimentally in a nitrogen environment and the graphitization process is accomplished separately in an argon environment.

The development of this process was verified in the following experimental procedure comprising i) dissolving the coating carbon precursor and dispersing coke particles in aqueous Coating Solution and at the same time diluting or dissolving the reacting agent in another aqueous Reacting Solution; ii) mixing the two solutions so that the carbon precursor and reacting agent react form solid precipitate on coke particles, iii) separating the resulting solids from the solution by filtration, iv) washing the solids with water to remove residual solution and drying the powder, and v) carbonizing the resulting solids to convert the coating precursor into carbon by heating in an inert environment. Six examples were prepared as shown in Table 1 below.

TABLE 1

| | | Coating Solution | | | Reacting solution | |
|---|---|---|---|---|---|---|
| Sample | W_{c} | Lignin | H₂O | (CH₃)₂CO | 70% HNO₃ | 30% H₂O₂ |
| Number | (g) | (g) | (g) | (g) | (g) | (g) |
| 1 | 10.21 | 3.07 | 29 | 5 | 2.13 | |
| 2 | 10.10 | 1.09 | 38 g | 3.0 | 2.83 | |
| | | | Filtrate | | | |
| 3 | 10.58 | 1.55 | 41 g | 3.0 | 1.69 | |
| | | | Filtrate | | | |
| 4 | 10.06 | 2.73 | 25 | 7.0 | 2.07 | 2.02 |
| 5 | 10.07 | 2.91 | 41 | 6.0 | 2.08 | 2.18 |
| 6 | 20.44 | 4.63 | 42 | 6.3 | 2.27 | |

The coated particles are characterized as shown in Table 2 below:

TABLE 2

Results

| Sample Number | μ_{cp} (wt %) | μ_{c} (wt %) |
|---|---|---|
| 1 | 4.4 | 1.6 |
| 2 | 6.6 | 3.7 |
| 3 | 4.7 | 0.9 |
| 4 | 8.3 | 3.4 |
| 5 | 9.0 | 3.8 |
| 6 | 7.4 | 3.4 |

In Table 2, the percentage of the solid lignin is reported for the resulting powder (μ_{cp}) along with the percentage of the lignin carbon in the carbonized sample (μ_{c}).

For the six samples above, a cell coin test was performed as explained below with the results in Table 3 following that.

A coin cell (CR2032 size) consists of lithium metal, a separator, the electrode, and electrolyte between the electrodes. The separator included a thin sheet of porous polypropylene (Cellguard® 2300) on the Li side and a glass fiber filter (Whatman® GF/B). The electrodes (1.5 cm diameter disks) were prepared with standard solvent casting method with polyvinyl difluoride (PVDF) as binder; the solid composition was 92 wt % active material, 2% carbon black, and 6 wt % PVDF. The material loading (active only) was about 10 mg/cm². The electrolyte was 1 M LiPF6 in the solvent mixture (40 v % ethylene carbonate, 30 v % dimethyl carbonates and 30 v % diethyl carbonate). Each cell was cycled five times under the conditions below: charging at constant current of 1 mA till the cell voltage reached zero volt and then at zero volts for one hour and subsequently discharging at constant current of 1 mA till the cell voltage reached two volts. The electrical charges accumulated during each charging and discharging cycles were used to calculate the specific capacity based on the total active electrode material in each cell. The tests were conducted with an electrochemical tester (Arbin® LBT21084) at ambient temperature (˜22° C.).

TABLE 3

| | | | Initial | Initial |
|---|---|---|---|---|
| | Lignin | Carbon | discharge | coulombic |
| | coating | coating | capacity | efficiency |
| Sample | level (%) | level (%) | (mAh/g) | (%) |
| 1 | 4.4 | 1.6 | 342.1 | 96.0 |
| 2 | 6.6 | 3.7 | 335.6 | 94.0 |
| 3 | 4.7 | 0.9 | 335.6 | 95.1 |
| 4 | 8.3 | 3.4 | 335.0 | 91.7 |
| 5 | 9.0 | 3.8 | 333.6 | 95.5 |
| 6 | 9.7 | 4.4 | 338.0 | 92.8 |

These are fully satisfactory attributes for high performance batteries and with this simpler and easier process with fewer ancillary concerns like recovering spent solvent or significant loss of product due to chipping and breaking, it is likely that the cost for anode material could be reduced for battery manufacturers.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiments of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process for producing core and shell particles where both the core and the shell are carbon-based materials that are precursors for graphitic battery anode powder, where the process comprises:
a) dissolving a water-soluble carbon precursor in water to form a liquid coating solution;
b) dispersing calcined petroleum coke in water to form a dispersion;
c) depositing the water-soluble carbon precursor as a coating on the calcined petroleum coke by oxidizing the water-soluble carbon precursor to form a solidified coating; and
d) separating the coated particles from the dispersion.

2. The process according to claim 1 wherein the step of oxidizing the water-soluble carbon precursor by oxidation comprises adding a liquid oxidant.

3. The process according to claim 1 where the water-soluble carbon precursor comprises lignin.

4. The process according to claim 3 where the step of oxidizing the water-soluble carbon precursor by oxidation comprises adding a nitric oxide.

5. The process according to claim 1 where the dispersion includes a wetting agent.

6. The process according to claim 5 where the wetting agent includes acetone.

7. The process according to claim 5 where the wetting agent includes N-Methyl-2-pyrrolidone.

8. The process according to claim 1 where calcined petroleum coke is calcined to a temperature above 1000° C.

9. The process according to claim 8 where calcined petroleum coke is calcined to a temperature above 1200° C.

10. The process according to claim 9 where calcined petroleum coke is calcined to a temperature about 1350° C.

11. The process according to claim 1 further including the step of combining the solution with the dispersion and further where the step of oxidizing the water-soluble carbon precursor by oxidation comprises adding a liquid oxidant to the solution prior to the step of combining the solution to the dispersion.

12. A process for producing graphitic anode powder comprising core and shell particles where both the core and the shell are carbon-based materials where the anode powder is suitable for use in the anode of a battery, where the process comprises:
a) dissolving a water-soluble carbon precursor in water to form a liquid coating solution;
b) dispersing calcined petroleum coke in water to form a dispersion;
c) depositing the water-soluble carbon precursor as a coating on the calcined petroleum coke by oxidizing the water-soluble carbon precursor to form a solidified coating;
d) separating the coated particles from the dispersion;
e) washing the coated particles; and
f) heating the coated particles in an oxygen free environment to convert the carbon precursor materials in the core and shell to graphite structures.

13. The process according to claim 12 wherein the step of oxidizing the water-soluble carbon precursor by oxidation comprises adding a liquid oxidant.

14. The process according to claim 12 where the water-soluble carbon precursor comprises lignin.

15. The process according to claim 14 where the step of oxidizing the water-soluble carbon precursor by oxidation comprises adding a nitric oxide.

16. The process according to claim 12 where the dispersion includes a wetting agent.

17. The process according to claim 16 where the wetting agent includes acetone.

18. The process according to claim 16 where the wetting agent includes N-Methyl-2-pyrrolidone.

19. The process according to claim 12 where calcined petroleum coke is calcined to a temperature above 1000° C.

20. The process according to claim 12 further including the step of combining the solution with the dispersion and further where the step of oxidizing the water-soluble carbon precursor by oxidation comprises adding a liquid oxidant to the solution prior to the step of combining the solution to the dispersion.
